(19) United States
(12) Patent Application Publication
(10) Pub. No.: US 2026/0009891 A1
(43) Pub. Date: Jan. 8, 2026

(54) DISPLACEMENT AMOUNT ESTIMATION DEVICE, DISPLACEMENT AMOUNT ESTIMATION METHOD, AND NON-TRANSITORY COMPUTER READABLE STORAGE MEDIUM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: MASAKI YONEDA, Nisshin-shi (JP)

(21) Appl. No.: 19/222,022

(22) Filed: May 29, 2025

(30) Foreign Application Priority Data
Jul. 3, 2024 (JP) 2024-107596

(51) Int. Cl. G01S 13/42; G01S 7/41; G01S 7/48; G01S 7/539; G01S 13/58; G01S 13/931; G01S 15/42; G01S 15/58; G01S 15/931; G01S 17/42; G01S 17/58; G01S 17/931

(52) U.S. Cl. CPC G01S 13/42; G01S 7/41; G01S 7/4802; G01S 7/539; G01S 13/58; G01S 13/931; G01S 15/42; G01S 15/58; G01S 15/931; G01S 17/42; G01S 17/58; G01S 17/931

(57) ABSTRACT

Distance measurement data, related to a position and Doppler speed of a distance measurement point detected by a distance measurement sensor, is acquired. An extraction point is extracted from the distance measurement data. The extraction point is a distance measurement point disposed outside a range between a position where a distance in a vertical direction from a road surface point is a first predetermined distance and a position where the distance in the vertical direction from the road surface point is a second predetermined distance larger than the first predetermined distance. The displacement amount of a mobile object movable on a road surface is estimated based on a value related to the Doppler speed of the extraction point.

### CROSS REFERENCE TO RELATED APPLICATION

The present application claims the benefit of priority from Japanese Patent Application No. 2024-107596 filed on Jul. 3, 2024. The entire disclosure of the above application is incorporated herein by reference.

### TECHNICAL FIELD

The present disclosure relates to a displacement amount estimation device, a displacement amount estimation method and a non-transitory computer readable storage medium.

### BACKGROUND

A technique for Doppler point group registration according to a conceivable technique is known. In the technique according to a conceivable technique, a first estimation point group of Doppler speed information is compared with a second point group of Doppler speed information to execute position alignment between the first point group and the second point group. Additionally, if the point group includes points that represent moving objects such as pedestrians, vehicles, raindrops, falling snow, and the like, then these points are determined to be exclusion points and the determined exclusion points are removed.

### SUMMARY

According to an example, distance measurement data, related to a position and Doppler speed of a distance measurement point detected by a distance measurement sensor, is acquired. An extraction point is extracted from the distance measurement data. The extraction point is a distance measurement point disposed outside a range between a position where a distance in a vertical direction from a road surface point is a first predetermined distance and a position where the distance in the vertical direction from the road surface point is a second predetermined distance larger than the first predetermined distance. The displacement amount of a mobile object movable on a road surface is estimated based on a value related to the Doppler speed of the extraction point.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a configuration diagram of a moving object in which a displacement amount estimation device according to a first embodiment is used;

FIG. 2 is a diagram showing a moving object and a distance measurement point;

FIG. 3 is a flowchart showing the process of the displacement amount estimation device;

FIG. 4 is a diagram for explaining a road surface height in the process of the displacement amount estimation device;

FIG. 5 is a diagram for explaining an extraction point in the process of the displacement amount estimation device;

FIG. 6 is a diagram showing the relationship between the azimuth angle and the Doppler speed of the extraction point;

FIG. 7 is a diagram for explaining estimation and association of distance measurement points in the process of a displacement amount estimation device according to a second embodiment;

FIG. 8 is a configuration diagram of a moving object in which a displacement amount estimation device according to a third embodiment is used;

FIG. 9 is a flowchart showing a process of a displacement amount estimation device according to a fourth embodiment;

FIG. 10 is a configuration diagram of a moving object in which a displacement amount estimation device according to a fifth embodiment is used;

FIG. 11 is a flowchart showing the process of the displacement amount estimation device;

FIG. 12 is a flowchart showing a process of a displacement amount estimation device according to a sixth embodiment; and

FIG. 13 is a diagram for explaining a first speed vector, a second speed vector, and a vector angle in the process of the displacement amount estimation device.

### DETAILED DESCRIPTION

When the relative speed of a stationary object with respect to a moving object is small, for example because the moving object is moving at a slow speed, the difference between the relative speed of the moving object with respect to an estimation target object whose amount of displacement is to be estimated and the relative speed of the stationary object required to estimate the amount of displacement with respect to the estimation target object whose amount of displacement is to be estimated becomes small. In this case, if the technique according to a conceivable technique is used, a point indicating a moving object may be treated as a point indicating a stationary object. If a point indicating a moving object is treated as a point indicating a stationary object, the accuracy of estimating the amount of displacement decreases.

An object of the present embodiments is to provide a displacement amount estimation device and a displacement amount estimation program that suppress a decrease in the estimation accuracy of a displacement amount.

The subject described in one feature relates to a displacement amount estimation device that estimates a displacement amount of a moving object which is moving on a road surface.

The displacement amount estimation device includes: an acquisition unit that acquires distance measurement data, which is data related to a position of a distance measurement point and a Doppler speed detected by a distance measurement sensor; an extraction unit that extracts from the distance measurement data an extraction point that is a distance measurement point disposed outside a range between a position where a distance in a vertical direction from a road surface point that is a distance measurement point on the road surface is a first predetermined distance and a position where a distance in the vertical direction from the road surface point is a second predetermined distance that is larger than the first predetermined distance; and an estimation unit that estimates the displacement amount based on a value related to a Doppler speed of the extraction point.

The subject described in another feature is a displacement amount estimation program for estimating a displacement amount of a moving object which is moving on a road surface.

The displacement amount estimation program causes a displacement amount estimation device to function as: an acquisition unit that acquires distance measurement data, which is data related to a position of a distance measurement point and a Doppler speed detected by a distance measurement sensor; an extraction unit that extracts from the distance measurement data an extraction point that is a distance measurement point disposed outside a range between a position where a distance in a vertical direction from a road surface point that is a distance measurement point on the road surface is a first predetermined distance and a position where a distance in the vertical direction from the road surface point is a second predetermined distance that is larger than the first predetermined distance; and an estimation unit that estimates the displacement amount based on a value related to a Doppler speed of the extraction point.

As a result, the distance measurement points of the moving object are excluded and the distance measurement points of the stationary object are extracted, regardless of the speed of the moving objects. This prevents the distance measurement points of a moving object from being treated as distance measurement points of a stationary object used to estimate the amount of displacement. Therefore, the deterioration of the estimation accuracy of the amount of displacement is suppressed.

Here, a parenthesized reference symbol attached to each constituent element or the like shows an example of the correspondence of the constituent element or the like and a specific constituent element or the like described in an embodiment to be described later.

Hereinafter, embodiments will be described with reference to the drawings. In the following embodiments, the same or equivalent parts are denoted by the same reference numerals as each other, and explanations will be provided to the same reference numerals.

### First Embodiment

The displacement amount estimation device that executes the displacement amount estimation program of the present embodiment suppresses a decrease in the estimation accuracy of the displacement amount. For example, the displacement amount estimation device is used in a moving object such as a vehicle. First, the moving object will be described.

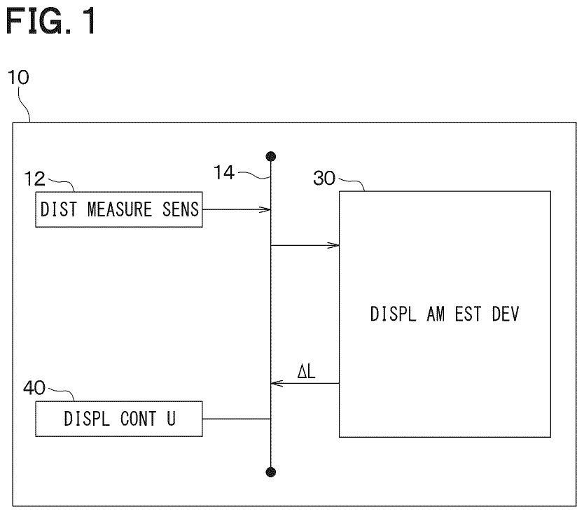

As shown in FIG. 1, a mobile object 10 is an estimation target for estimating a displacement amount ΔL, and includes a distance measurement sensor 12, a displacement amount estimation device 30, and a displacement control unit 40.

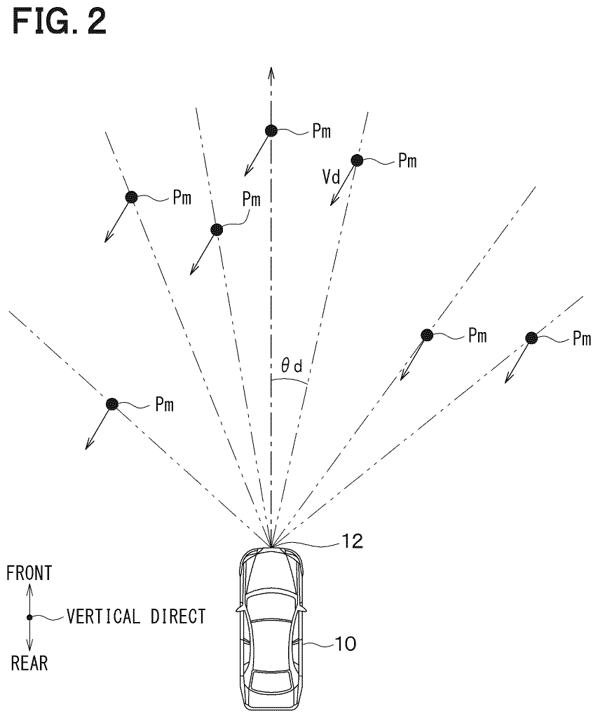

The distance measurement sensor 12 includes a radar, LiDAR, sonar, and the like that uses radio waves such as millimeter waves. As a result, the distance measurement sensor 12 uses exploration waves such as electromagnetic waves and ultrasonic waves to detect a point group having at least one distance measurement point Pm, which is a point for each position on an object in front of the mobile object 10, as shown in FIG. 2. The distance measurement sensor 12 also detects the position, azimuth angle θd, and Doppler speed Vd of the distance measurement point Pm using the reflected wave, frequency, and the like of the exploration wave. Furthermore, the distance measurement sensor 12 outputs data relating to the position, azimuth angle θd, and Doppler speed Vd of the distance measurement point Pm as distance measurement data to a displacement amount estimation device 30 described later via a LAN 14 such as a CAN as shown in FIG. 1. Here, the Doppler speed Vd here is the relative speed of the distance measurement point Pm with respect to the distance measurement sensor 12.

The displacement amount estimation device 30 mainly includes a microcomputer and has a CPU, a ROM, a flash memory, a RAM, an I/O, a communication interface, and a bus line connecting these components. In addition, the displacement amount estimation device 30 executes a program stored in the ROM of the displacement amount estimation device 30 to estimate the displacement amount ΔL of the mobile object 10 based on the distance measurement data from the distance measurement sensor 12. Furthermore, the displacement amount estimation device 30 outputs the estimated displacement amount ΔL via the LAN 14 to a displacement control unit 40 described later. The estimation of the displacement amount ΔL by the displacement amount estimation device 30 will be described in detail later.

The displacement control unit 40 includes an engine, a motor, and a drive circuit for driving these. Further, the displacement control unit 40 controls the engine, the motor and the drive circuit based on the displacement amount ΔL from the displacement amount estimation device 30. In this way, the displacement control unit 40 controls the displacement of the mobile object 10.

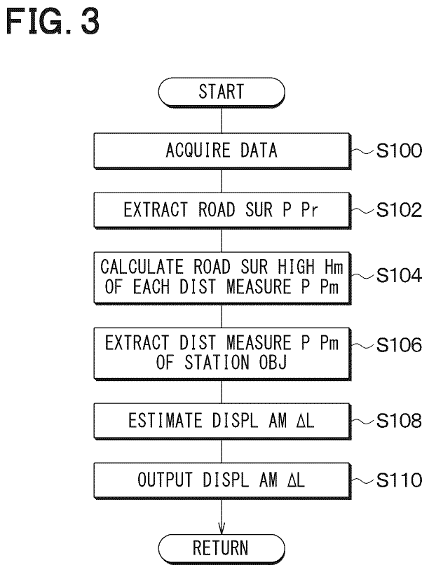

The mobile object 10 is configured as described above. Next, the details of the estimation of the displacement amount ΔL by the program execution of the displacement amount estimation device 30 will be described with reference to the flowchart of FIG. 3 and FIGS. 4 to 6. The program of the displacement amount estimation device 30 is executed, for example, when the power supply of the mobile object 10 is turned on.

As shown in the flowchart of FIG. 3, in step S100, the displacement amount estimation device 30 acquires distance measurement data from the distance measurement sensor 12.

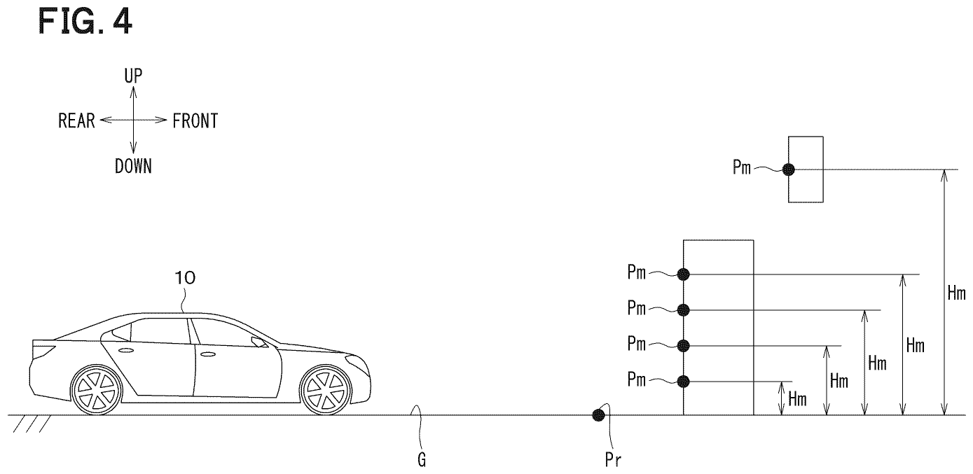

Next, in step S102, the displacement amount estimation device 30 extracts a road surface point Pr, which is a distance measurement point Pm on the road surface G on which the mobile object 10 is moving, from the distance measurement data acquired in step S100, as shown in FIG. 4. The displacement amount estimation device 30 extracts the road surface points Pr using a method such as plane surface fitting or curved surface fitting.

Next, in step S104, the displacement amount estimation device 30 calculates the road surface height Hm for each distance measurement point Pm from the extracted road surface point Pr. The road surface height Hm is the distance in the vertical direction from the road surface point Pr to the distance measurement point Pm.

Here, the distance measurement point Pm of the moving object becomes noise in estimating the amount of displacement ΔL using the Doppler speed Vd. Furthermore, the distance measurement point Pm where the road surface height Hm is the same as the height of the mobile object 10 is highly likely to be the distance measurement point Pm of a moving object that is moving on the road surface G together with the mobile object 10. As a result, the distance measurement point Pm where the road surface height Hm is different from the height of the mobile object 10 is highly likely to be the distance measurement point Pm of a stationary object.

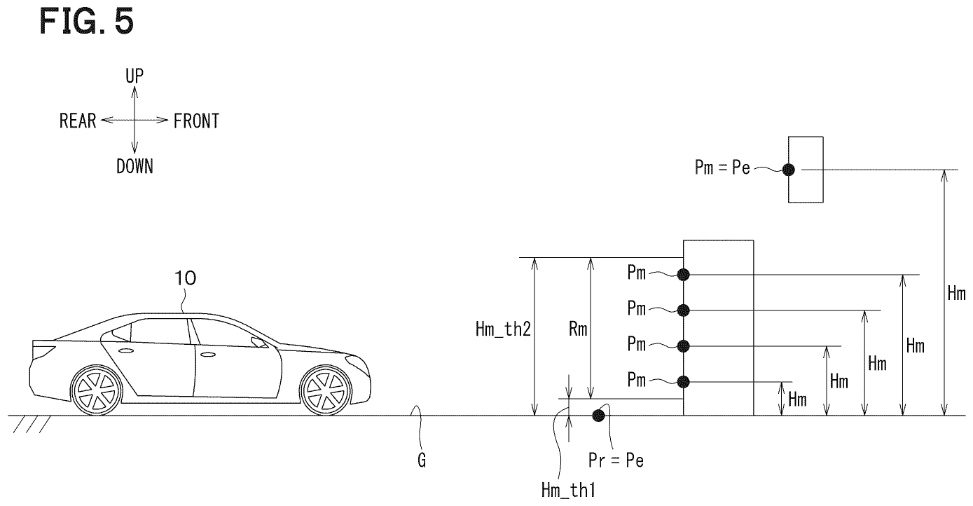

Therefore, in step S106 following step S104, the displacement amount estimation device 30 uses the road surface height Hm calculated in step S104 to extract a distance measurement point Pm whose distance from the road surface point Pr is outside a predetermined distance range Rm, as shown in FIG. 5. As a result, the displacement amount estimation device 30 removes the distance measurement point Pm of the moving object from the distance measurement data acquired in step S100, and extracts the distance measurement point Pm of the stationary object. Furthermore, the displacement amount estimation device 30 sets this extracted distance measurement point Pm as an extraction point Pe. The extraction points Pe also include the road surface point Pr. The predetermined distance range Rm is the range from a position whose distance from the road surface point Pr in the vertical direction is a first predetermined distance Hm_th1 to a position whose distance from the road surface point Pr in the vertical direction is a second predetermined distance Hm_th2. The second predetermined distance Hm_th2 is greater than the first predetermined distance Hm_th1. Furthermore, the first predetermined distance Hm_th1 and the second predetermined distance Hm_th2 are set by experiment, simulation, or the like so that the distance measurement point Pm of a moving object is excluded from the distance measurement data.

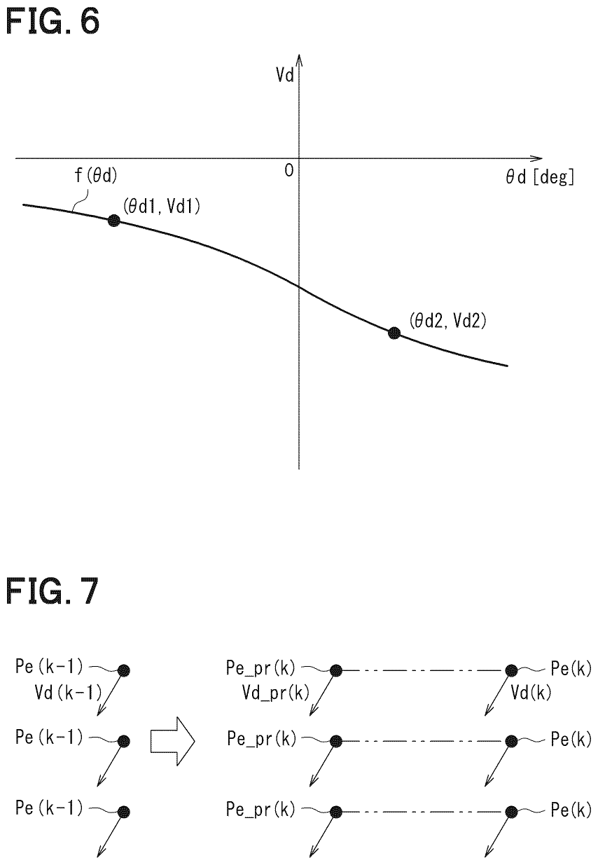

Returning to the flowchart of FIG. 3, in step S108 following step S106, the displacement amount estimation device 30 extracts the azimuth angle θd and the Doppler speed Vd of the extraction point Pe extracted in step S106 from the distance measurement data acquired in step S100. Further, as shown in FIG. 6, the displacement amount estimation device 30 calculates a function f(θd) of the Doppler speed Vd of the extraction point Pe with respect to the azimuth angle θd of the extraction point Pe. The function f(θd) is expressed, for example, by a trigonometric function.

Here, as shown in FIG. 6, it is assumed that the extracted azimuth angles θd and Doppler speeds Vd of two points are obtained. The azimuth angle θd of one of the two points is defined as θd1. The Doppler speed Vd corresponding to θd1 is defined as Vd1. The azimuth angle θd of the other of the two points is defined as θd1. The Doppler speed Vd corresponding to θd2 is defined as Vd2. The speed of the distance measurement sensor 12 in the front and rear directions of the mobile object 10 is represented as Vx. The speed of the distance measurement sensor 12 in the left-right direction of the mobile object 10 is represented as Vy.

And, θd1, Vd1, θd2, Vd2, Vx, and Vy are expressed by the following relational expression (1). Further, the displacement amount estimation device 30 substitutes the extracted θd1, Vd1, θd2, and Vd2 into the following relational expression (1). In this way, the displacement amount estimation device 30 calculates Vx and Vy.

$$( Expression 1 )$$

$$[ \begin{matrix}Vx \\ Vy\end{matrix} ] = {[ \begin{matrix}cos ( θ d 1 ) & sin ( θ d 1 ) \\ cos ( θ d 2 ) & sin ( θ d 2 )\end{matrix} ]}^{- 1} \times [ \begin{matrix}Vd 1 \\ Vd 2\end{matrix} ] \qquad ( 1 )$$

Further, the magnitude of the speed of the distance measurement sensor 12 is defined as Vs. The angle related to the speed direction of the distance measurement sensor 12 is defined as α.

Furthermore, Vs is expressed by using Vx and Vy as in the following relational expression (2-1). Moreover, α is expressed by the following relational expression (2-2) using Vx and Vy. Furthermore, the displacement amount estimation device 30 substitutes the calculated Vx and Vy into the following relational expressions (2-1) and (2-2). In this way, the displacement amount estimation device 30 calculates Vs and a.

$$( Expressions 2 - 1 and 2 - 2 )$$

$$Vs = \sqrt{{Vx}^{2} + {Vy}^{2}} \qquad ( 2 - 1 )$$

$$α = tan ( \frac{Vy}{Vx} ) \qquad ( 2 - 2 )$$

Here, the distance from the reference position of the mobile object 10 to the distance measurement sensor 12 in the front and rear direction of the mobile object 10 is defined as B. The distance from the reference position of the mobile object 10 to the distance measurement sensor 12 in the left-right direction of the mobile object 10 is defined as I. The angle of the direction of the distance measurement sensor 12 relative to the front and rear direction of the mobile object 10 is defined as β. The speed of the mobile object 10 is defined as V. The angular speed of the mobile object 10 is defined as ω. The reference position of the mobile object 10 is, for example, the center of gravity of the mobile object 10. B, I, and β are set in advance in the displacement amount estimation device 30.

Furthermore, V is expressed by the following relational expression (3-1) using Vs, α, β, B, and I. Further, ω is expressed by the following relational expression (3-2) using Vs, α, β, and I. Furthermore, the displacement amount estimation device 30 substitutes the calculated Vs and α and the predetermined β, B, and I into the following relational expression (3-1). In this way, the displacement amount estimation device 30 calculates V. Furthermore, the displacement amount estimation device 30 substitutes the calculated Vs and α and the predetermined β, and I into the following relational expression (3-2). In this way, the displacement amount estimation device 30 calculates ω.

$$( Expressions 3 - 1 and 3 - 2 )$$

$$V = ( cos ( α + β ) - \frac{B}{I} \times sin ( α + β ) ) \times Vs \qquad ( 3 - 1 )$$

$$ω = \frac{sin ( α + β )}{I} \times Vs \qquad ( 3 - 2 )$$

Further, the amount of displacement ΔL of the mobile object 10 in the front and rear direction is defined as ΔX. The amount of displacement ΔL of the mobile object 10 in the left-right direction is defined as ΔY. The amount of change in the yaw angle of the mobile object 10 is defined as Δθ. The period of a series of operations from when the process of step S100 of the displacement amount estimation device 30 is started to when the process of step S100 is returned is defined as a control period of the displacement amount estimation device 30, and is defined as ΔT.

ΔX, ΔY, and Δθ are expressed by the following relational expression (4) using V, ω, and ΔT. Further, the displacement amount estimation device 30 substitutes the calculated V, ω, and a predetermined ΔT into the following relational expression (4). In this way, the displacement amount estimation device 30 estimates the displacement amount ΔL.

$$( Expression 4 )$$

$$Δ L = [ \begin{matrix}Δ X \\ Δ Y \\ Δ θ\end{matrix} ] = [ \begin{matrix}\frac{V}{ω} \times sin ( ω \times Δ T ) \\ \frac{V}{ω} \times ( 1 - cos ( ω \times Δ T ) ) \\ ω \times Δ T\end{matrix} ] \qquad ( 4 )$$

Returning to the flowchart of FIG. 3, in step S110 following step S108, the displacement amount estimation device 30 outputs the displacement amount ΔL estimated in step S108 to the displacement control unit 40 via the LAN 14. Further, the displacement control unit 40 controls the engine, the motor and the drive circuit based on the displacement amount ΔL from the displacement amount estimation device 30. In this way, the displacement control unit 40 controls the displacement of the mobile object 10. After that, the process of the displacement amount estimation device 30 returns to step S100.

As described above, the displacement amount estimation device 30 estimates the displacement amount ΔL. Next, how the displacement amount estimation device 30 suppresses a decrease in the estimation accuracy of the displacement amount ΔL will be described.

Here, when the relative speed of a stationary object with respect to a moving object is small, for example, because the moving object is moving at a slow speed, the difference between the relative speed of the moving object with respect to the mobile object 10 and the relative speed of the stationary object required to estimate the displacement amount ΔL with respect to the mobile object 10 becomes small. In this case, if the technique according to a conceivable technique is used, a point indicating a moving object may be treated as a point indicating a stationary object. If a point indicating a moving object is treated as a point indicating a stationary object, the accuracy of estimating the displacement amount ΔL decreases.

Also, in the technique according to a conceivable technique, a first estimated point group of Doppler speed information is compared with a second point group of Doppler speed information. Further, in the estimating of the amount of displacement ΔL using the azimuth angle θd and Doppler speed Vd of the distance measurement point Pm, it is assumed that the mobile object 10 makes a sudden change such as a sudden acceleration/deceleration, a sudden turn, or a sudden pitching. At this time, the error of the first estimated point group of Doppler speed information increases due to the sudden change in the speed and angular speed caused by the sudden change. Therefore, in this case, if the technique according to a conceivable technique is used, it becomes difficult to distinguish between the moving object and the stationary object. Therefore, when the mobile object 10 makes sudden changes such as sudden acceleration/deceleration, sudden turns, and sudden pitching, the accuracy of estimating the amount of displacement ΔL decreases if the technique according to a conceivable technique is used.

In contrast to this feature, the displacement amount estimation device 30 of this embodiment serves as an acquisition unit that acquires the distance measurement data. Furthermore, the displacement amount estimation device 30 serves as an extraction unit that extracts an extraction point Pe, which is a distance measurement point Pm located outside the predetermined distance range Rm, from the distance measurement data. As described above, the predetermined distance range Rm corresponds to the range from a position whose distance from the road surface point Pr in the vertical direction is the first predetermined distance Hm_th1 to a position whose distance from the road surface point Pr in the vertical direction is the second predetermined distance Hm_th2. The displacement amount estimation device 30 also serves as an estimation unit that estimates the displacement amount ΔL based on a value related to the Doppler speed Vd of the extraction point Pe. Further, here, the displacement amount estimation device 30 estimates the displacement amount ΔL based on a value related to the azimuth angle θd of the extraction point Pe in addition to a value related to the Doppler speed Vd of the extraction point Pe.

As a result, the distance measurement points Pm of the moving object are excluded and the distance measurement points Pm of the stationary object are extracted, regardless of the speed of the moving objects. This prevents the distance measurement point Pm of a moving object from being treated as the distance measurement point Pm of a stationary object used for estimating the amount of displacement ΔL. Therefore, the deterioration of the estimation accuracy of the amount of displacement ΔL is suppressed.

Furthermore, even if the mobile object 10 makes sudden changes such as sudden acceleration/deceleration, sudden turning, and sudden pitching, the distance measurement points Pm of moving objects are removed and the distance measurement points Pm of stationary objects are extracted. Accordingly, similar to the above feature, this prevents the distance measurement point Pm of a moving object from being treated as the distance measurement point Pm of a stationary object used for estimating the amount of displacement ΔL. Therefore, even if the mobile object 10 makes sudden changes such as sudden acceleration/deceleration, sudden turning, or sudden pitching, the deterioration of the estimation accuracy of the displacement amount ΔL is suppressed.

### Second Embodiment

In the second embodiment, the method of estimating the displacement amount ΔL in step S108 differs from that in the first embodiment. The other configurations are the same as those of the first embodiment.

Here, the period of a series of operations from when the process of step S100 of the displacement amount estimation device 30 is started to when the process of step S100 is returned is defined as a control period of the displacement amount estimation device 30.

Then, in step S108, the displacement amount estimation device 30 estimates the position and Doppler speed Vd of the extraction point Pe extracted in the present control period, as shown in FIG. 7, without using the azimuth angle θd. For example, the displacement amount estimation device 30 defines that the mobile object 10 moves at a constant speed and a constant acceleration. Furthermore, the displacement amount estimation device 30 estimates the estimation position and estimation Doppler speed Vd_pr of the extraction point Pe extracted in the present control period from the distance measurement point Pm acquired in the previous control period and the displacement amount ΔL estimated in the previous control period. The displacement amount ΔL estimated in the previous control period corresponds to the displacement amount ΔL estimated before the present time. Further, the distance measurement point Pm and the displacement amount ΔL used in the estimation of the first control period are set by experiment, simulation, or the like so that the estimation position of the extraction point Pe and the estimation Doppler speed Vd_pr of the extraction point Pe can be estimated. Furthermore, in FIG. 7, the extraction point Pe extracted in the previous control period is indicated as Pe(k−1). The Doppler speed Vd in the previous control period is indicated as Vd(k−1). The extraction point Pe acquired in the present control period is indicated as Pe(k). The Doppler speed Vd in the present control period is indicated as Vd(k). The extraction point Pe estimated in the present control period is indicated as Pe_pr(k). The estimation Doppler speed Vd_pr estimated in the present control period is indicated as Vd_pr(k). k is a natural number of 2 or more.

Then, the displacement amount estimation device 30 estimates the displacement amount ΔL using ICP or the like. Note that ICP is an abbreviation for Iterative Closest Point.

Specifically, the displacement amount estimation device 30 uses a nearest neighbor search or the like to associate the estimation position and estimation Doppler speed Vd_pr of the estimation extraction point Pe_pr with the position and Doppler speed Vd of the extraction point Pe extracted in the present control period. In this way, the displacement amount estimation device 30 associates the estimation extraction point Pe_pr with the extraction point Pe extracted in the present control period. The estimation extraction point Pe_pr corresponds to the estimated extraction point Pe.

Furthermore, the displacement amount estimation device 30 calculates a rotation matrix and a translation vector for the mobile object 10 from the corresponding positions and Doppler speeds Vd. Furthermore, the displacement amount estimation device 30 repeats the above-described calculation of the rotation matrix and the translation vector and the above-described association by the nearest neighbor search or the like. Then, the displacement amount estimation device 30 calculates a rotation matrix and a translation vector that minimizes the sum of squares of the errors of the corresponding positions and Doppler speeds Vd. This rotation matrix corresponds to the change in the attitude of the mobile object 10. Furthermore, this translation vector corresponds to the change in position of the mobile object 10. Therefore, the displacement amount estimation device 30 estimates the displacement amount ΔL from the rotation matrix and the translation vector that minimize the sum of squares of the errors of the corresponding positions and Doppler speeds Vd.

As described above, in the displacement amount estimation device 30 of the second embodiment, the displacement amount ΔL is estimated in step S108. The second embodiment achieves effects similar to the effects achieved by the first embodiment. In the second embodiment, the following effects are also achieved.

In estimating the amount of displacement ΔL using the estimation position of the estimation extraction point Pe_pr and the estimation Doppler speed Vd_pr, if the mobile object 10 makes a sudden change such as a sudden acceleration/deceleration, a sudden turn, or a sudden pitching, the estimation error becomes large. As a result, when the estimation of the displacement amount ΔL using the estimation position and the estimation Doppler speed Vd_pr is combined with the technique according to a conceivable technique, the estimation error of the distance measurement points Pm of a moving object and a stationary object becomes large. Therefore, in this case, if the technique according to a conceivable technique is used, it becomes difficult to distinguish between the moving object and the stationary object. Therefore, when the mobile object 10 makes a sudden displacement, if the technique according to a conceivable technique is used to estimate the displacement amount ΔL using the estimation position and estimation Doppler speed Vd_pr, a point indicating a moving object may be treated as a point indicating a stationary object. If a point indicating a moving object is treated as a point indicating a stationary object, the accuracy of estimating the displacement amount ΔL decreases.

In contrast, the displacement amount estimation device 30 of the second embodiment estimates the displacement amount ΔL using the estimation position and estimation Doppler speed Vd_pr, and as described above, even if the mobile object 10 makes a sudden change, the distance measurement point Pm of the moving object is removed and the distance measurement point Pm of the stationary object is extracted. This prevents the distance measurement point Pm of a moving object from being treated as the distance measurement point Pm of a stationary object used for estimating the amount of displacement ΔL. Therefore, even if the mobile object 10 makes sudden changes such as sudden acceleration/deceleration, sudden turns, and sudden pitching, the accuracy of estimating the amount of displacement ΔL using the estimation position and estimation Doppler speed Vd_pr is prevented from decreasing.

### Third Embodiment

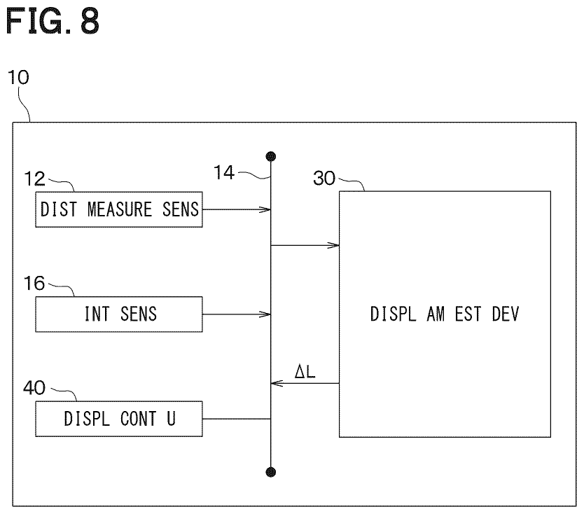

In the third embodiment, as shown in FIG. 8, the mobile object 10 further includes an internal sensor 16. Furthermore, the process of the displacement amount estimation device 30 differs from that of the second embodiment. The other configurations are the same as those of the second embodiment.

The internal sensor 16 includes a speed sensor, a steering angle sensor, an IMU, and the like, and detects the state of the mobile object 10, for example, the speed, acceleration, attitude, and the like of the mobile object 10. Note that IMU is an abbreviation for Inertial Measurement Unit.

In step S100, the displacement amount estimation device 30 acquires the state of the mobile object 10 from the internal sensor 16 in addition to the distance measurement data from the distance measurement sensor 12. Furthermore, the displacement amount estimation device 30 executes the processes from step S102 to step S106 in the same manner as in the second embodiment.

In step S108 following step S106, the displacement amount estimation device 30 estimates the estimation position and estimation Doppler speed Vd_pr of the extraction point Pe extracted in the present control period without using the displacement amount ΔL estimated in the previous control period. Specifically, instead of the displacement amount ΔL estimated in the previous control period, the displacement amount estimation device 30 estimates the estimation position and estimation Doppler speed Vd_pr of the extraction point Pe from the distance measurement point Pm acquired in the previous control period and the state of the mobile object 10 acquired in the previous control period.

Then, in the same manner as described above, the displacement amount estimation device 30 uses the ICP to associate the estimation extraction point Pe_pr with the extraction point Pe extracted in the present control period. Furthermore, the displacement amount estimation device 30 calculates the rotation matrix and the translation matrix from the associated estimation extraction point Pe_pr and the extraction point Pe. Furthermore, the displacement amount estimation device 30 estimates the displacement amount ΔL from the calculated rotation matrix and translation matrix. Furthermore, the displacement amount estimation device 30 executes the process of step S110 subsequent to step S108 in the same manner as in the second embodiment.

As described above, the mobile object 10 including the displacement amount estimation device 30 of the third embodiment is configured, and the process of the displacement amount estimation device 30 is executed. The third embodiment achieves effects similar to the effects achieved by the second embodiment.

### Fourth Embodiment

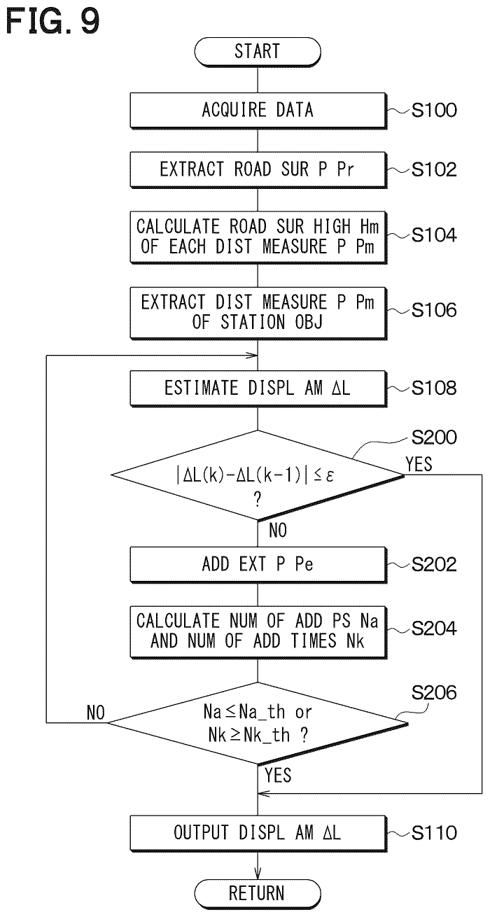

In the fourth embodiment, as shown in the flowchart of FIG. 9, the process of the displacement amount estimation device 30 differs from that in the first embodiment. The other configurations are the same as those of the first embodiment.

Here, the period of a series of operations from when the process of step S100 of the displacement amount estimation device 30 is started to when the process of step S100 is returned is defined as a control period of the displacement amount estimation device 30.

Furthermore, the displacement amount estimation device 30 executes the processes from step S100 to step S108 in the same manner as in the first embodiment.

Also, here, when the mobile object 10 is moving normally, there is little variation between the present displacement amount ΔL(k) estimated in the present control period and the previous displacement amount ΔL(k−1) estimated in the previous control period. Therefore, when the mobile object 10 is moving normally, the absolute value of the difference between the present displacement amount ΔL(k) estimated in the present control period and the previous displacement amount ΔL(k−1) estimated in the previous control period is small. On the other hand, when the absolute value of the difference between the present displacement amount ΔL(k) estimated in the present control period and the previous displacement amount ΔL(k−1) estimated in the previous control period is large, there is a possibility that the estimation of the displacement amount ΔL has not converged to a proper value. Furthermore, since the estimation of the displacement amount ΔL has not converged to a proper value, the error included in the estimated displacement amount ΔL may be large, or the estimation accuracy of the displacement amount ΔL may be low.

Therefore, in step S200 following step S108, the displacement amount estimation device 30 calculates the absolute value of “|ΔL(k)−ΔL(k−1)|” of the difference between the present displacement amount ΔL(k) and the previous displacement amount ΔL(k−1). Furthermore, the displacement amount estimation device 30 determines whether the calculated absolute value of the difference of “|ΔL(k)−ΔL(k−1)|” is equal to or smaller than a threshold value ¿. The threshold value ε is set by experiment, simulation, or the like so that it can be determined whether the absolute value of the difference of “|ΔL(k)−ΔL(k−1)|” is proper.

When the absolute value of the difference of “|ΔL(k)−ΔL(k−1)|” is equal to or smaller than the threshold value ε, the difference between the present displacement amount ΔL(k) and the previous displacement amount ΔL(k−1) is small. Therefore, at this time, the process of the displacement amount estimation device 30 proceeds to step S110. Furthermore, when the absolute value of the difference of “|ΔL(k)−ΔL(k−1)|” is greater than the threshold ε, the absolute value of the difference between the present displacement amount ΔL(k) and the previous displacement amount ΔL(k−1) is large. In this case, since the estimation of the displacement amount ΔL has not converged to a proper value, the error included in the estimated displacement amount ΔL may be large, or the estimation accuracy of the displacement amount ΔL may be low. Therefore, at this time, the process of the displacement amount estimation device 30 proceeds to step S202.

In step S202 following step S200, since there is a possibility that the error included in the estimated displacement amount ΔL is large or the estimation accuracy of the displacement amount ΔL is low, the displacement amount estimation device 30 adds an extraction point Pe. The extraction point Pe extracted in step S106 corresponds to the first extraction point. The extraction point Pe added in step S202 corresponds to the second extraction point.

Here, the distance measurement point Pm that has the closer distance with the road surface point Pr and/or has a Doppler speed Vd close to the road surface point Pr is likely to be a distance measurement point Pm of a stationary object.

For this reason, the displacement amount estimation device 30 extracts, for example, a distance measurement point Pm whose shortest distance from the road surface point Pr is less than a distance threshold and whose absolute value of the difference with the Doppler speed Vd of the road surface point Pr is less than a speed difference threshold as the second extraction point. As a result, the displacement amount estimation device 30 re-extracts the distance measurement point Pm of the stationary object. Furthermore, the displacement amount estimation device 30 adds the distance measurement points Pm of the stationary object re-extracted in step S202 to the point group of the distance measurement points Pm of the stationary object extracted in step S106. The distance threshold and the speed difference threshold are set by experiment, simulation, or the like so that the distance measurement point Pm of a stationary object can be re-extracted.

Furthermore, when the distance measurement points Pm are clustered, the size of a cluster of stationary objects is likely to be larger than the size of a cluster of moving objects. The size of the cluster is the size of the collection of classified distance measurement points Pm.

For this reason, the displacement amount estimation device 30 executes clustering of the distance measurement points Pm from the distance measurement data acquired in step S100, for example. Furthermore, the displacement amount estimation device 30 extracts, as a second extraction point, a distance measurement point Pm for which the size of the cluster for the clustered distance measurement point Pm is equal to or larger than a cluster threshold. As a result, the displacement amount estimation device 30 re-extracts the distance measurement point Pm of the stationary object. Furthermore, the displacement amount estimation device 30 adds the distance measurement points Pm of the stationary object re-extracted in step S202 to the point group of the distance measurement points Pm of the stationary object extracted in step S106. The cluster threshold is set by experiment, simulation, or the like so that the distance measurement points Pm of stationary objects can be re-extracted.

In step S204 following step S202, the displacement amount estimation device 30 calculates the number of addition points Na. The number of addition points Na is the number of extraction points Pe added in step S202.

Furthermore, the displacement amount estimation device 30 calculates the present number of addition times Nk by adding, for example, 1 to the previous number of addition times Nk. The number of addition times Nk is the number of times the process of step S202 has been executed.

In step S206 following step S204, the displacement amount estimation device 30 determines whether or not the number of addition points Na calculated in step S204 is equal to or less than a threshold number of points Na_th. In this way, the displacement amount estimation device 30 determines whether the number of additional points Na in step S202 is too small. The threshold number of points Na_th is set by experiment, simulation, or the like so as to determine whether the number of addition points Na in step S202 is too small or not.

In addition, the displacement amount estimation device 30 determines whether the number of addition times Nk calculated in step S204 is equal to or greater than a threshold number of times Nk_th. As a result, the displacement amount estimation device 30 prevents the processes from step S200 to step S206 from continuing indefinitely. The threshold number Nk_th is set by experiment, simulation, or the like so that the processes from step S200 to step S206 are not repeated indefinitely.

When the number of addition points Na is equal to or smaller than the threshold number of points Na_th, the number of additions of extraction points Pe in step S202 is too small, so even if extraction points Pe are added, the effect on the estimation of the displacement amount ΔL is small. Therefore, at this time, the process of the displacement amount estimation device 30 proceeds to step S110. Alternatively, when the number of addition times Nk is equal to or greater than the threshold number of times Nk_th, the process of the displacement amount estimation device 30 proceeds to step S110.

Furthermore, when the number of addition points Na is greater than the threshold number of points Na_th, the number of addition extraction points Pe in step S202 is not too small, and is sufficient here. Therefore, at this time, the process of the displacement amount estimation device 30 returns to step S108. Alternatively, when the number of addition times Nk is smaller than the threshold number of times Nk_th, the process of the displacement amount estimation device 30 returns to step S108. In step S108, the extraction point Pe in step S202 is added to the extraction point Pe in step S106, and the displacement amount ΔL is re-estimated.

In step S110, the displacement amount estimation device 30 outputs the displacement amount ΔL estimated in step S108 to the displacement control unit 40 via the LAN 14. Further, the displacement control unit 40 controls the engine, the motor and the drive circuit based on the displacement amount ΔL from the displacement amount estimation device 30. In this way, the displacement control unit 40 controls the displacement of the mobile object 10. After that, the process of the displacement amount estimation device 30 returns to step S100.

As described above, the displacement amount estimation device 30 of the fourth embodiment executes the process. The fourth embodiment achieves effects similar to the effects achieved by the first embodiment. In the fourth embodiment, the following effects are also achieved.

[1-1]

In step S202, the displacement amount estimation device 30 adds an extraction point Pe. For example, the displacement amount estimation device 30 adds, for example, a distance measurement point Pm whose shortest distance from the road surface point Pr is less than a distance threshold and whose absolute value of the difference with the Doppler speed Vd of the road surface point Pr is less than a speed difference threshold, as the second extraction point. Alternatively, the displacement amount estimation device 30 adds, as a second extraction point, a distance measurement point Pm for which the size of a cluster for the clustered distance measurement points Pm is equal to or larger than a cluster threshold.

As a result, the number of extraction points Pe increases, and the number of distance measurement points Pm for stationary objects increases. This suppresses the deterioration of the estimation accuracy of the displacement amount ΔL.

[1-2]

When the number of addition points Na is greater than the threshold number of points Na_th in the processes from step S108 to step S206, the displacement amount estimation device 30 re-estimates the displacement amount ΔL.

In this way, when the number of second extraction points is relatively large, the displacement amount ΔL is estimated. This suppresses the deterioration of the estimation accuracy of the displacement amount ΔL.

[1-3]

The displacement amount estimation device 30 outputs the displacement amount ΔL when the number of addition times Nk is equal to or greater than the threshold number of times Nk_th in steps S202, S204, S206, and S110.

As a result, when the number of addition times Nk reaches the threshold number of times Nk_th, the addition of the extraction point Pe in step S202 is not executed, and the displacement amount ΔL is output. This prevents the addition of the extraction point Pe in step S202 from continuing indefinitely.

### Fifth Embodiment

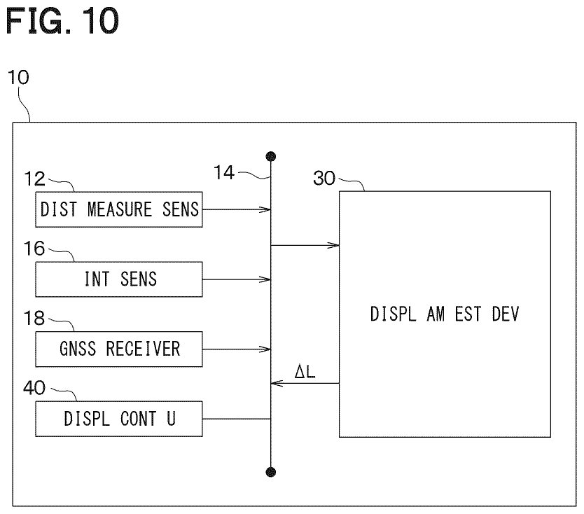

In the fifth embodiment, as shown in FIG. 10, the mobile object 10 further includes an internal sensor 16 and a GNSS receiver 18. Furthermore, the process of the displacement amount estimation device 30 differs from that of the fourth embodiment. The other configurations are the same as those of the fourth embodiment.

The internal sensor 16 detects the state of the mobile object 10, such as the speed, acceleration, and attitude of the mobile object 10, in the same manner as described above. As a result, the internal sensor 16 corresponds to a state estimation unit that estimates the state of the mobile object 10.

The GNSS receiver 18 receives signals from a plurality of positioning satellites (not shown). Furthermore, the GNSS receiver 18 calculates the GNSS absolute position, GNSS absolute orientation, GNSS speed and the like of the mobile object 10 based on the received signals. As a result, the GNSS receiver 18 corresponds to a state estimation unit that estimates the state of the mobile object 10. In addition, the GNSS receiver 18 outputs the calculated GNSS absolute position, GNSS absolute orientation, GNSS speed, and the like to the displacement amount estimation device 30. The positioning satellites used in the GNSS receiver 18 include, for example, GPS satellites, GLONASS satellites, Galileo satellites, and quasi-zenith satellites.

In step S100, the displacement amount estimation device 30 acquires the speed, acceleration and attitude of the mobile object 10 from the internal sensor 16 as the state of the mobile object 10, in addition to the distance measurement data from the distance measurement sensor 12. Furthermore, the displacement amount estimation device 30 acquires the GNSS absolute position, the GNSS absolute orientation, and the GNSS speed from the GNSS receiver 18 as the state of the mobile object 10. In addition, the displacement amount estimation device 30 acquires a point group of distance measurement points Pm indicating positions around the mobile object 10 from a database or the like outside the mobile object 10. After the process of step S100, the displacement amount estimation device 30 executes the processes of steps S102 to S106 in the same manner as in the second embodiment.

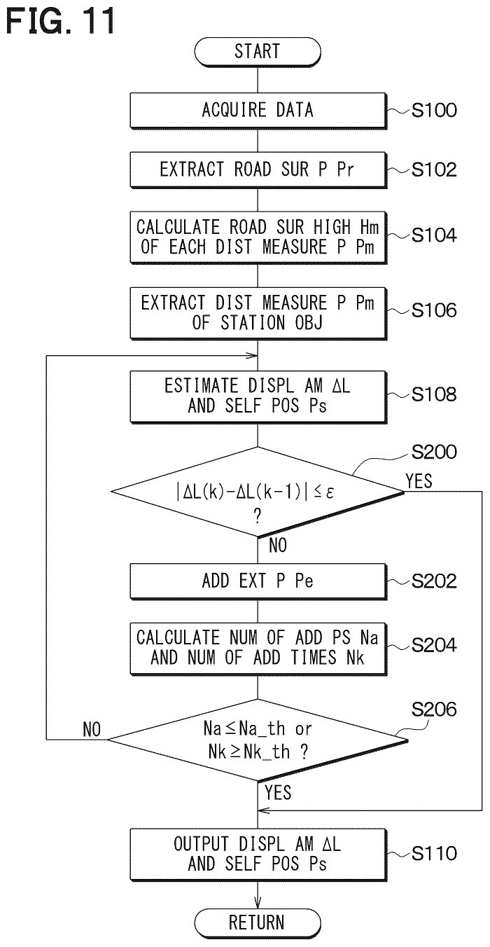

Then, as shown in the flowchart of FIG. 11, in step S108 following step S106, the displacement amount estimation device 30 estimates the displacement amount ΔL in the same manner as described above. Furthermore, the displacement amount estimation device 30 estimates the self-position Ps in addition to the displacement amount ΔL. The self-position Ps corresponds to the position of the mobile object 10 in the point group of the distance measurement points Pm.

Specifically, the displacement amount estimation device 30 calculates a search range for the point group of the distance measurement points Pm acquired from a database or the like in step S100, based on the state of the mobile object 10 acquired in step S100. In addition, the displacement amount estimation device 30 uses the ICP to associate the distance measurement point Pm in the calculated search range with the extraction point Pe extracted in step S106 and the extraction point Pe added in step S202. In this way, the displacement amount estimation device 30 estimates the self position Ps. After the process of step S108, the displacement amount estimation device 30 executes the processes of steps S200 to S206 in the same manner as in the second embodiment.

Then, in step S110 following step S206, the displacement amount estimation device 30 outputs the self-position Ps estimated in step S108 to the displacement control unit 40 via the LAN 14 in addition to the displacement amount ΔL estimated in step S108. The displacement control unit 40 controls the engine, the motor, and the drive circuit based on the displacement amount ΔL from the displacement amount estimation device 30 and the self-position Ps. In this way, the displacement control unit 40 controls the displacement of the mobile object 10. After that, the process of the displacement amount estimation device 30 returns to step S100.

As described above, the mobile object 10 including the displacement amount estimation device 30 of the fifth embodiment is configured, and the process of the displacement amount estimation device 30 is executed. The fifth embodiment achieves effects similar to the effects achieved by the fourth embodiment. In the fifth embodiment, the following effects are also achieved.

[2-1]

In step S108, the displacement amount estimation device 30 estimates the self-position Ps by associating the point group of the distance measurement points Pm with the extraction points Pe.

This makes it possible to control the displacement of the mobile object 10 using the self-position Ps in addition to the displacement amount ΔL. This makes it easier to control the displacement of the mobile object 10.

[2-2]

The displacement amount estimation device 30 calculates a search range for the point group of the distance measurement points Pm based on the state of the mobile object 10. Furthermore, the displacement amount estimation device 30 estimates the self-position Ps by associating the distance measurement points Pm in the search range with the extraction points Pe. As described above, the state of the mobile object 10 is, for example, the speed, acceleration, and attitude of the mobile object 10 detected by the internal sensor 16. Alternatively, the state of the mobile object 10 is the GNSS absolute position, the GNSS absolute orientation, and the GNSS speed calculated by the GNSS receiver 18.

By calculating the above search range, it becomes easier to associate the distance measurement points Pm with the extraction points Pe. This suppresses the deterioration of the estimation accuracy of the self-position Ps.

### Sixth Embodiment

In the sixth embodiment, the mobile object 10 further includes an internal sensor 16 and a GNSS receiver 18. Furthermore, the process of the displacement amount estimation device 30 differs from that of the first embodiment. The other configurations are the same as those of the first embodiment.

The internal sensor 16 detects the speed, acceleration and attitude of the mobile object 10 in the same manner as described above. Furthermore, the internal sensor 16 estimates a first speed vector V1, which is the speed vector of the mobile object 10, based on the detected speed, acceleration, and attitude of the mobile object 10. Therefore, the internal sensor 16 corresponds to a vector estimation unit that estimates the first speed vector V1.

As described above, the GNSS receiver 18 calculates the GNSS absolute position, GNSS absolute orientation, GNSS speed nad the like of the mobile object 10 based on signals received from a plurality of positioning satellites. In addition, the GNSS receiver 18 estimates a first speed vector V1 based on the calculated GNSS absolute position, GNSS absolute orientation and GNSS speed of the mobile object 10. Therefore, the GNSS receiver 18 corresponds to a vector estimation unit that estimates the first speed vector V1.

In step S100, the displacement amount estimation device 30 acquires a first speed vector V1 from the internal sensor 16 and the GNSS receiver 18 in addition to the distance measurement data from the distance measurement sensor 12. After the process of step S100, the displacement amount estimation device 30 executes the processes of steps S102 to S108 in the same manner as in the second embodiment.

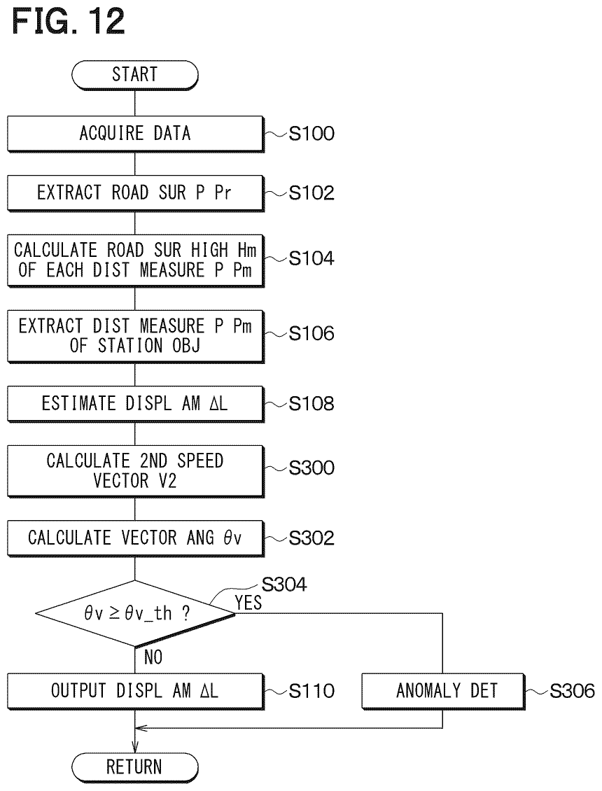

Then, as shown in the flowchart of FIG. 12, in step S300 following step S108, the displacement amount estimation device 30 calculates a second speed vector V2 from the displacement amount ΔL estimated in step S108.

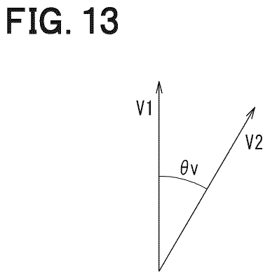

Subsequently, in step S302, the displacement amount estimation device 30 calculates a vector angle θv, as shown in FIG. 13, from the first speed vector V1 acquired in step S100 and the second speed vector V2 estimated in step S300. The vector angle θv is the angle between the first speed vector V1 and the second speed vector V2.

Returning to the flowchart in FIG. 12, in step S304 following step S302, the displacement amount estimation device 30 determines whether or not the vector angle θv calculated in step S302 is equal to or greater than a threshold angle θv_th. In this way, the displacement amount estimation device 30 determines whether the deviation in the attitude of the mobile object 10 is large.

When the vector angle θv is less than the threshold angle θv_th, the deviation in the attitude of the mobile object 10 is small, so the process of the displacement amount estimation device 30 proceeds to step S110. In step S110, since the reliability of the estimation of the displacement amount ΔL is high, the displacement amount estimation device 30 outputs the displacement amount ΔL estimated in step S108 to the displacement control unit 40 via the LAN 14. Furthermore, when the vector angle θv is equal to or greater than the threshold angle θv_th, the deviation in the attitude of the mobile object 10 is large, and the process of the displacement amount estimation device 30 proceeds to step S306.

In step S306 following step S304, since the deviation in the attitude of the mobile object 10 is large, the displacement amount estimation device 30 determines that the mobile object 10 has anomaly. Furthermore, the displacement amount estimation device 30 outputs a signal indicating that the mobile object 10 has anomaly to the displacement control unit 40 via the LAN 14. When the displacement control unit 40 receives a signal indicating that the mobile object 10 has anomaly from the displacement amount estimation device 30, the displacement control unit 40 stops the mobile object 10, for example. Alternatively, for example, the displacement control unit 40 outputs an alarm using text display, sound, and light. After that, the process of the displacement amount estimation device 30 returns to step S100.

As described above, the mobile object 10 including the displacement amount estimation device 30 of the sixth embodiment is configured, and the process of the displacement amount estimation device 30 is executed. The sixth embodiment achieves effects similar to the effects achieved by the first embodiment. In the sixth embodiment, the following effects are also achieved.

In step S302, the displacement amount estimation device 30 calculates the vector angle θv based on the first speed vector V1 and the second speed vector V2. Furthermore, in steps S304 and S306, the displacement amount estimation device 30 serves as a determination unit that determines that the mobile object 10 has anomaly when the vector angle θv is equal to or greater than the threshold angle θv_th. The vector angle θv corresponds to a value related to the deviation of the attitude of the mobile object 10. Furthermore, the threshold angle θv_th corresponds to the deviation threshold.

This allows a determination as to whether or not there is a deviation in the attitude of the mobile object 10. Therefore, the anomaly in the mobile object 10 can be determined.

### Other Embodiments

The present disclosure is not limited to the above-described embodiments, and the above-described embodiments can be appropriately modified. Individual elements or features of a particular embodiment are not necessarily essential unless it is specifically stated that the elements or the features are essential in the foregoing description, or unless the elements or the features are obviously essential in principle.

The acquisition unit, the extraction unit, the estimation unit and the determination unit and methods thereof described in the present disclosure may be realized by a dedicated computer provided by configuring a processor, programmed to execute one or more functions embodied by a computer program, and a memory. Alternatively, the acquisition unit, the extraction unit, the estimation unit and the determination unit and methods thereof described in the present disclosure may be realized by a dedicated computer provided by configuring a processor with one or more dedicated hardware logic circuits. Alternatively, the acquisition unit, the extraction unit, the estimation unit and the determination unit and methods thereof described in the present disclosure may be realized by one or more dedicated computers configured by a combination of a processor programmed to execute one or more functions, a memory, and a processor configured by one or more hardware logic circuits. The computer program may also be stored on a computer-readable and non-transitory tangible storage medium as an instruction executed by a computer.

In each of the above embodiments, the road surface height Hm is the distance in the vertical direction from the road surface point Pr to the distance measurement point Pm. Alternatively, the road surface height Hm may be the distance in the vertical direction from a plane or curved surface that passes through the road surface point Pr to the distance measurement point Pm. A plane or a curved surface passing through the road surface points Pr is estimated by, for example, plane fitting or curved surface fitting. As a result, when the distance measurement point Pm on the road surface G is detected by the distance measurement sensor 12 and then, when the distance measurement point Pm is no longer detected, the distance measurement point Pm of a stationary object is extracted.

In the first embodiment, the displacement amount estimation device 30 estimates the displacement amount ΔL based on values related to the azimuth angle θd and the Doppler speed Vd of the extraction point Pe. Alternatively, the displacement amount estimation device 30 may estimate the displacement amount ΔL based only on the value related to the Doppler speed Vd at the extraction point Pe.

In the fifth embodiment, the point group of the distance measurement points Pm is a point group stored in a database outside the mobile object 10. Alternatively, the point group of the distance measurement points Pm may not be limited to being a point group stored in a database external to the mobile object 10, but may be, for example, a point group of the distance measurement points Pm stored by the distance measurement sensor 12 of the mobile object 10.

The above-described embodiments may be combined as appropriate.

### (Various Features of Present Embodiments)

Feature 1: A displacement amount estimation device estimates a displacement amount of a mobile object that is movable on a road surface. The displacement amount estimation device includes: at least one of (i) a circuit and (ii) a processor having a memory storing computer program code. The at least one of the circuit and the processor having the memory is configured to cause the displacement amount estimation device to provide at least one of: an acquisition unit that acquires distance measurement data, which is related to a position and Doppler speed of a distance measurement point detected by a distance measurement sensor; an extraction unit that extracts from the distance measurement data an extraction point that is a distance measurement point disposed outside a range between a position where a distance in a vertical direction from a road surface point that is the distance measurement point on the road surface is a first predetermined distance and a position where a distance in the vertical direction from the road surface point is a second predetermined distance that is larger than the first predetermined distance; and an estimation unit that estimates the displacement amount based on a value related to the Doppler speed of the extraction point.

Feature 2: In the displacement amount estimation device according to feature 1, the acquisition unit acquires data related to an azimuth angle of the distance measurement point. The estimation unit estimates the displacement amount based on a value related to the Doppler speed and a value related to the azimuth angle of the extraction point.

Feature 3: In the displacement amount estimation device according to feature 1, the estimation unit: estimates the value related to a Doppler speed and a value related to a position of the extraction point; associates an estimation extraction point that is an estimated extraction point with the extraction point extracted by the extraction unit; and estimates the displacement amount based on values related to the Doppler speeds and values related to the positions of the estimation extraction point and the extraction point that are associated with each other.

Feature 4: In the displacement amount estimation device according to feature 3, the estimation unit estimates the values related to the positions and the values related to the Doppler speeds of the extraction point based on the displacement amount estimated prior to a present time.

Feature 5: In the displacement amount estimation device according to feature 3, the acquisition unit acquires a state of the mobile object detected by an internal sensor that detects a state of the mobile object. The estimation unit estimates the values related to the positions and the values related to the Doppler speeds of the extraction point extracted by the extraction unit based on the state of the mobile object.

Feature 6: In the displacement amount estimation device according to any one of features 1 to 5, the extraction point is a first extraction point. The extraction unit extracts, from the distance measurement data, a second extraction point that is the distance measurement point whose distance from the road surface point is equal to or less than a threshold distance and whose absolute value of a difference between the Doppler speed of the distance measurement point and the Doppler speed of the road surface point is equal to or less than a threshold speed difference. The estimation unit estimates the displacement amount based on values related to the Doppler speeds at the first extraction point and the second extraction point.

Feature 7: In the displacement amount estimation device according to any one of features 1 to 5, the extraction point is a first extraction point. The extraction unit clusters the distance measurement point, and extracts, from the distance measurement data, a second extraction point that is the distance measurement point having a cluster size for a clustered distance measurement point is equal to or larger than a threshold cluster size. The estimation unit estimates the displacement amount based on values related to the Doppler speeds at the first extraction point and the second extraction point.

Feature 8: In the displacement amount estimation device according to feature 6 or 7, the estimation unit estimates the displacement amount based on values related to the Doppler speeds of the first extraction point and the second extraction point when a numerical number of points of the second extraction point is greater than a threshold numerical number of points.

Feature 9: In the displacement amount estimation device according to any one of features 6 to 8, the estimation unit outputs the displacement amount when a numerical number of times that the second extraction point is extracted is equal to or greater than a threshold numerical number.

Feature 10: In the displacement amount estimation device according to any one of features 1 to 9, the estimation unit estimates a position of the mobile object in a point group by associating the point group of the distance measurement point with the extraction point.

Feature 11: In the displacement amount estimation device according to feature 10, the acquisition unit acquires a state of the mobile object estimated by a state estimation unit that estimates the state of the mobile object, the estimation unit: calculates a search range for the point group based on the state of the mobile object; and estimates the position of the mobile object in the point group by associating the distance measurement point in the search range with the extraction point.

Feature 12: In the displacement amount estimation device according to any one of features 1 to 11, the acquisition unit acquires a first speed vector which is a speed vector of the mobile object estimated by a vector estimation unit which estimates the speed vector of the mobile object; and the estimation unit estimates a value related to a deviation in an attitude of the mobile object based on the first speed vector and a second speed vector which is the speed vector of the mobile object based on the displacement amount.

Feature 13: The displacement amount estimation device according to feature 12, further includes: a determination unit that determines that the mobile object has an anomaly when a value related to the deviation in the attitude of the mobile object is equal to or greater than a threshold deviation.

Feature 14: A displacement amount estimation program for estimating a displacement amount of a mobile object that is movable on a road surface, causes the displacement amount estimation device to function as: an acquisition unit that acquires distance measurement data, which is related to a position and Doppler speed of a distance measurement point detected by a distance measurement sensor; an extraction unit that extracts from the distance measurement data an extraction point that is a distance measurement point disposed outside a range between a position where a distance in a vertical direction from a road surface point that is the distance measurement point on the road surface is a first predetermined distance and a position where a distance in the vertical direction from the road surface point is a second predetermined distance that is larger than the first predetermined distance; and an estimation unit that estimates the displacement amount based on a value related to a Doppler speed of the extraction point.

Reference number 10 indicates a mobile object, reference number 12 indicates a distance measurement sensor, reference number 16 indicates an internal sensor, reference number 18 indicates a GNSS receiver, reference number 30 indicates a displacement amount estimation device, reference number Vd indicates Doppler speed, reference number Pm indicates a Distance measurement point, reference number Pr indicates a road surface point, and reference number Pe indicates an extraction point.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a displacement amount estimation device to perform functions” should be understood that (i) only the circuit can cause a displacement amount estimation device to perform all the functions, (ii) only the processor can cause a displacement amount estimation device to perform all the functions, or (iii) the circuit can cause a displacement amount estimation device to perform at least one of the functions and the processor can cause a displacement amount estimation device to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A displacement amount estimation device estimates a displacement amount of a mobile object that is movable on a road surface, the displacement amount estimation device comprising:
an acquisition unit that acquires distance measurement data, which is related to a position and Doppler speed of a distance measurement point detected by a distance measurement sensor;
an extraction unit that extracts from the distance measurement data an extraction point that is the distance measurement point disposed outside a range between a position where a distance in a vertical direction from a road surface point that is the distance measurement point on a road surface is a first predetermined distance and a position where the distance in the vertical direction from the road surface point is a second predetermined distance that is larger than the first predetermined distance; and
an estimation unit that estimates the displacement amount based on a value related to the Doppler speed of the extraction point.

2. The displacement amount estimation device according to claim 1, wherein:
the acquisition unit acquires data related to an azimuth angle of the distance measurement point; and
the estimation unit estimates the displacement amount based on the value related to the Doppler speed of the extraction point and a value related to the azimuth angle of the extraction point.

3. The displacement amount estimation device according to claim 1, wherein:
the estimation unit:
estimates the value related to the Doppler speed of the extraction point and a value related to a position of the extraction point;
associates an estimation extraction point that is an estimated extraction point with the extraction point extracted by the extraction unit; and
estimates the displacement amount based on values related to the Doppler speeds and values related to the positions of the estimation extraction point and the extraction point that are associated with each other.

4. The displacement amount estimation device according to claim 3, wherein:
the estimation unit estimates the value related to the Doppler speed of the extraction point and the value related to the position of the extraction point based on the displacement amount estimated prior to a present time.

5. The displacement amount estimation device according to claim 3, wherein:
the acquisition unit acquires a state of the mobile object detected by an internal sensor that detects the state of the mobile object; and
the estimation unit estimates the value related to the Doppler speed of the extraction point and the value related to the position of the extraction point extracted by the extraction unit based on the state of the mobile object.

6. The displacement amount estimation device according to claim 1, wherein:
the extraction point is a first extraction point;
the extraction unit extracts, from the distance measurement data, a second extraction point that is the distance measurement point whose distance from the road surface point is equal to or less than a threshold distance and whose absolute value of a difference between the Doppler speed of the distance measurement point and the Doppler speed of the road surface point is equal to or less than a threshold speed difference; and
the estimation unit estimates the displacement amount based on a value related to the Doppler speed of the first extraction point and a value related to the Doppler speed of the second extraction point.

7. The displacement amount estimation device according to claim 1, wherein:
the extraction point is a first extraction point;
the extraction unit clusters the distance measurement point, and extracts, from the distance measurement data, a second extraction point that is the distance measurement point having a cluster size of a clustered distance measurement point is equal to or larger than a threshold cluster size; and
the estimation unit estimates the displacement amount based on a value related to the Doppler speed of the first extraction point and a value related to the Doppler speed of the second extraction point.

8. The displacement amount estimation device according to claim 6, wherein:
the estimation unit estimates the displacement amount based on the value related to the Doppler speed of the first extraction point and the value related to the Doppler speed of the second extraction point when a numerical number of points of the second extraction point is equal to or greater than a threshold numerical number of points.

9. The displacement amount estimation device according to claim 6, wherein:
the estimation unit outputs the displacement amount when a numerical number of extraction times of the second extraction point is equal to or greater than a threshold numerical number of extraction times.

10. The displacement amount estimation device according to claim 1, wherein:
the estimation unit estimates a position of the mobile object in a point group by associating the point group of the distance measurement point with the extraction point.

11. The displacement amount estimation device according to claim 10, wherein:
the acquisition unit acquires a state of the mobile object estimated by a state estimation unit that estimates the state of the mobile object; and
the estimation unit:
calculates a search range for the point group based on the state of the mobile object; and
estimates the position of the mobile object in the point group by associating the distance measurement point in the search range with the extraction point.

12. The displacement amount estimation device according to claim 1, wherein:
the acquisition unit acquires a first speed vector which is a speed vector of the mobile object estimated by a vector estimation unit which estimates the speed vector of the mobile object; and
the estimation unit estimates a value related to a deviation in an attitude of the mobile object based on the first speed vector and a second speed vector which is the speed vector of the mobile object based on the displacement amount.

13. The displacement amount estimation device according to claim 12, further comprising:
a determination unit that determines that the mobile object has an anomaly when the value related to the deviation in the attitude of the mobile object is equal to or greater than a threshold deviation.

14. The displacement amount estimation device according to claim 1, further comprising:
at least one of (i) a circuit and (ii) a processor having a memory storing computer program code, wherein:
the at least one of the circuit and the processor having the memory is configured to cause the displacement amount estimation device to provide at least one of: the acquisition unit; the extraction unit; and the estimation unit.

15. A non-transitory tangible computer readable storage medium comprising instructions being executed by a computer, the instructions including a computer-implemented method for estimating a displacement amount of a mobile object that is movable on a road surface, the instructions including:
acquiring distance measurement data, which is related to a position and Doppler speed of a distance measurement point detected by a distance measurement sensor;
extracting from the distance measurement data an extraction point that is a distance measurement point disposed outside a range between a position where a distance in a vertical direction from a road surface point that is the distance measurement point on a road surface is a first predetermined distance and a position where the distance in the vertical direction from the road surface point is a second predetermined distance that is larger than the first predetermined distance; and
estimating the displacement amount based on a value related to the Doppler speed of the extraction point.

16. A displacement amount estimation method for estimating a displacement amount of a mobile object that is movable on a road surface, the displacement amount estimation method comprising:
acquiring distance measurement data, which is related to a position and Doppler speed of a distance measurement point detected by a distance measurement sensor;
extracting from the distance measurement data an extraction point that is a distance measurement point disposed outside a range between a position where a distance in a vertical direction from a road surface point that is the distance measurement point on a road surface is a first predetermined distance and a position where the distance in the vertical direction from the road surface point is a second predetermined distance that is larger than the first predetermined distance; and
estimating the displacement amount based on a value related to the Doppler speed of the extraction point.
